(19) United States
(12) Patent Application Publication
(10) Pub. No.: US 2024/0223870 A1
(43) Pub. Date: Jul. 4, 2024

(54) DYNAMIC VIDEO PLACEMENT ADVERTISEMENTS

(71) Applicant: International Business Machines Corporation, Armonk, NY (US)

(72) Inventors: Yang LIU, Zhong Xin City (CN); Yuan Yuan DING, Shanghai (CN); Yi Chen ZHONG, Shanghai (CN); Hong Bing ZHANG, Beijing (CN)

(21) Appl. No.: 18/148,339

(22) Filed: Dec. 29, 2022

(51) Int. Cl. H04N 21/81; G06Q 30/0251; G06T 7/70; G06T 17/00

(52) U.S. Cl. CPC H04N 21/812; G06Q 30/0255; G06Q 30/0269; G06T 7/70; G06T 17/00

(57) ABSTRACT

Embodiments of the present disclosure provide enhanced systems and methods for generating enhanced dynamic video placement advertisements with scene recognition and user portrait analysis. One disclosed method comprises analyzing a video to identify a scene from video content based on a scene model pool providing scene recognition for the video. User portrait analysis for users enables generating customized advertising content for a given user based on user interests or preference. Video content can be customized for specific users with scene recognition enabling effective video advertising and improved user enjoyment.

### BACKGROUND

The present invention relates to the data processing field, and more specifically, to generating precise and dynamic video placement advertisements with scene recognition and user portrait analysis.

Existing methods of video placement advertising generally fail to provide effective performance or user satisfaction. In a first method, a popup advertisement window appears in front of a video being viewed, requiring users to close the popup advertisement window to continue viewing the video. In a second method, commercials are included when shooting movies and various videos. In a third method, advertisements are provided before or within a video, requiring users to play through the advertisements to view the video. It is not possible to change advertisements added during filming and these advertisements may not be of interest for many users. Disadvantages of the current methods include poor user experience, users do not like the popup advertisements (e.g., are unrelated to users' interests), or interruptions in videos for advertisements.

A need exists for new techniques for generating dynamic video placement advertisements that enable effective performance and user satisfaction.

### SUMMARY

Embodiments of the present disclosure provide a system and methods for generating enhanced dynamic video placement advertisements with scene recognition and user portrait analysis.

A non-limiting computer-implemented method comprises analyzing a video to identify a scene model based on scene recognition in the video. Based on the identified scene model, a video advertisement object is generated for the video. An advertising video 3D model can be selected for the generated video advertisement object based on the video analysis. User portrait analysis for users enables generating customized advertising content for a specific user. Video with customized advertisements are rendered based on the generated video advertisement content and user information.

Another non-limiting computer-implemented method comprises analyzes the video data, identifies 6DOF (Six degrees of freedom) of an object in the video according to the scene information, and renders a selected 3D model in the video to replace the identified 6DOF of the video object.

Other disclosed embodiments include a computer system and computer program product for generating dynamic video advertisements implementing features of the above-disclosed method.

### BRIEF DESCRIPTION OF THE DRAWINGS

FIG. 1 is a block diagram of an example computer environment for use in conjunction with one or more disclosed embodiments for generating precise and dynamic video advertisements of disclosed embodiments;

FIG. 2 is a block diagram of an example system for generating precise and dynamic advertisements with scene recognition and user portrait analysis of disclosed embodiments;

FIG. 3 is a flow chart schematically illustrating example operations of Video advertisement system of FIG. 2 for generating precise and dynamic advertisements with scene recognition and user portrait analysis of disclosed embodiments;

FIG. 4 is a flow chart illustrating example operations of a method for generating precise and dynamic advertisements with scene recognition and user portrait analysis of disclosed embodiments;

FIG. 5 is diagram schematically illustrating example operations for scene classification and advertisement selection of Video advertisement system of FIG. 2 of disclosed embodiments;

FIG. 6 is diagram schematically illustrating example operations for object identification and 6DOF pose recognition of Video advertisement system of FIG. 2 of disclosed embodiments; and

FIG. 7 is diagram schematically illustrating example operations of predicting user tags of Video advertisement system of FIG. 2 of disclosed embodiments;

### DETAILED DESCRIPTION

An enhanced system and methods for generating effective dynamic video placement advertisements with scene recognition and user portrait analysis are disclosed. One disclosed non-limiting computer-implemented method comprises analyzing a video to identify a scene based on a scene model for scene recognition in the video. Based on the identified scene model, one or more video advertisement objects can be selected for the video. For example, scene classification in the video can be determined based on a comparison with a stored scene model pool, and used to identify some components, such as candidate video objects to be added to video advertisements. For example after identifying parking lots in video content, car-related advertisements can be selected to add specific cars by brand and model to video parking lot scenes. User preference tags or a trained dataset are generated for collected user information such as the user's browsing history, video watching history, and other features. User preference tags or trained dataset can be obtained for example with Artificial Neural Network (ANN) training. Customized advertising content can be effectively generated for each user according to identified user's portrait information of disclosed embodiments.

Evaluating video data based on accurate scene classification and user portrait information enables using advertising 3D models. The video data is processed to enable the dynamic addition of the 3D models. According to the result of scene understanding and user portrait information, advertising content can be customized for specific users in appropriate scenes, which can achieve more effective video advertising and improve user enjoyment at the same time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Advertisement Generation Control Component 182, Scene Model Pool 184, Advertisement Pool 186, and 3D CAD Object Model Pool 188 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

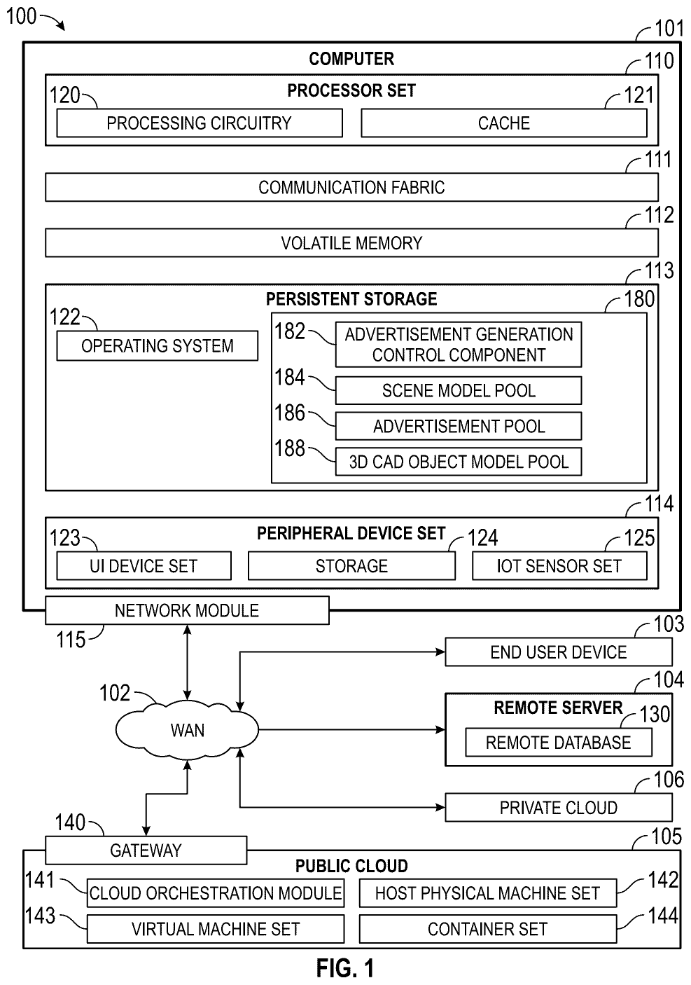

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure provide an enhanced video advertisement system and methods for generating enhanced dynamic video placement advertisements with scene recognition and user portrait analysis. One disclosed method comprises analyzing a video to identify a scene based on a scene model pool, providing scene recognition in the video. Based on the identified video scenes, one or more video advertisement components can be selected to add to the video. For example, scene classification in the video can be determined based on comparison of scenes with a stored scene model pool. In one embodiment, the scene recognition or classification in the video is used to identify some advertisement components, such as candidate video clips and objects to be added to the generated video advertisements. For example with parking lots identified in the video content, car-related advertisements can be selected to add specific candidate video objects, such as cars by brand and model to video parking lot scenes. User preference tags or trained dataset are generated for collected user information such as the user's browsing history, video watching history, and other features. User preference tags or trained dataset can be obtained for example with Artificial Neural Network (ANN) training. Customized advertising content can be effectively generated for each user according to identified user's portrait information of disclosed embodiments.

In accordance with some disclosed embodiments, valuating video data based on accurate scene classification and user portrait information enables using effective advertising 3D models, for example 3D models. The video data is processed to enable the dynamic addition of effective video advertisements. According to the result of scene understanding and user portrait information, advertising content can be customized for specific users in product related scenes identified in the video content, which can achieve more effective dynamic video placement advertising and can improve user enjoyment at the same time.

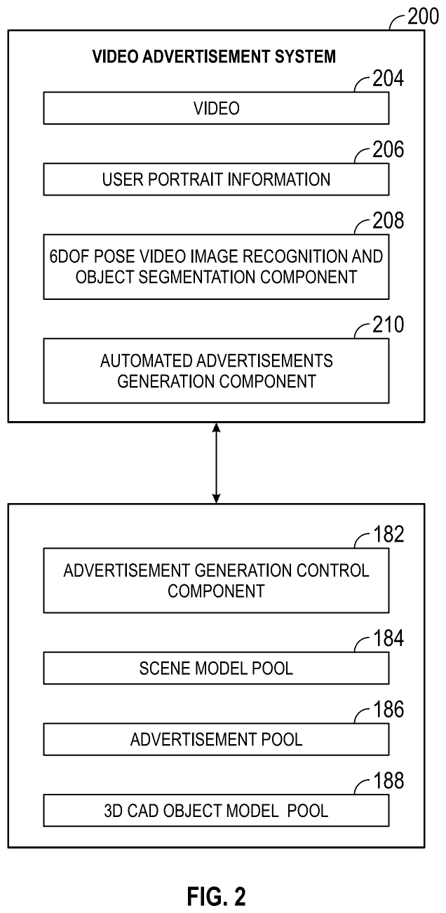

FIG. 2 illustrates an example video advertisement system 200 for generating and embedding dynamic video advertisements into video content. Video advertisement system 200 can be used in conjunction with the computer 101 and cloud environment of the computing environment 100 of FIG. 1 for generating enhanced dynamic video placement advertisements with scene recognition and user portrait analysis of disclosed embodiments.

Video advertisement system 200 receives a video 204 and analyzes video content data to identify a scene model, for example from a Scene Model Pool 184, based on scene recognition in the video. Video advertisement system 200 uses collected user portrait information 206 to generate video advertisements for specific users in the video 204. For example, user preference tags or trained dataset for collected user information 206 such as the user's browsing history, video watching history, age, and other features, can be obtained for example with ANN training. Video advertisement system 200 comprises a 6DOF (Six degrees of freedom) Pose Video Image Recognition and Object Segmentation Component 208 and Automated Advertisements Generation Component 210 of disclosed embodiments. For example, according to the recognized scenes, video advertisement system 200 with the Automated Advertisements Generation Component 210 can select products and brands candidates for generating the video advertisements. Video advertisement system 200 provides selected commercial product candidates with the start and end time of the video scene. Video advertisement system 200 uses the a 6DOF Pose Video Image Recognition and Object Segmentation Component 208 to recognize the 6DOF pose of identified 3D objects related to the advertising commodities objects (obtained from the 3D CAD Object Model Pool 188) in the video image. Video advertisement system 200 renders the video with customized advertisements with 6DOF pose for the selected 3D model commercial products based on the user preference tags for collected user information 206. Video advertisement system 200 can replace image objects by the selected advertising objects and add selected advertising objects to the related area of the video image. For example, Video advertisement system 200 can replace or add advertising objects with the same orientation and 6DOF pose as the video image to blend into the video content and look natural in the video image. The selected advertising objects comprise 3D objects, such as computers, printers, and various other office equipment with text or graphics identify product brands and manufacturers. Possible selected 3D advertising objects include many other products and product types, for example, food products (e.g., various staple food products, restaurant delivered products, and the like) and drink products (e.g., sodas, juice, and the like.)

Video advertisement system 200 comprises the Advertisement Generation Control Component 182, Scene Model Pool 184, Advertisement Pool 186, and 3D CAD Object Model Pool 188 for use in conjunction with the computer 101 and cloud environment of the computing environment 100 of FIG. 1 for generating precise and dynamic video placement advertisements of one or more disclosed embodiments.

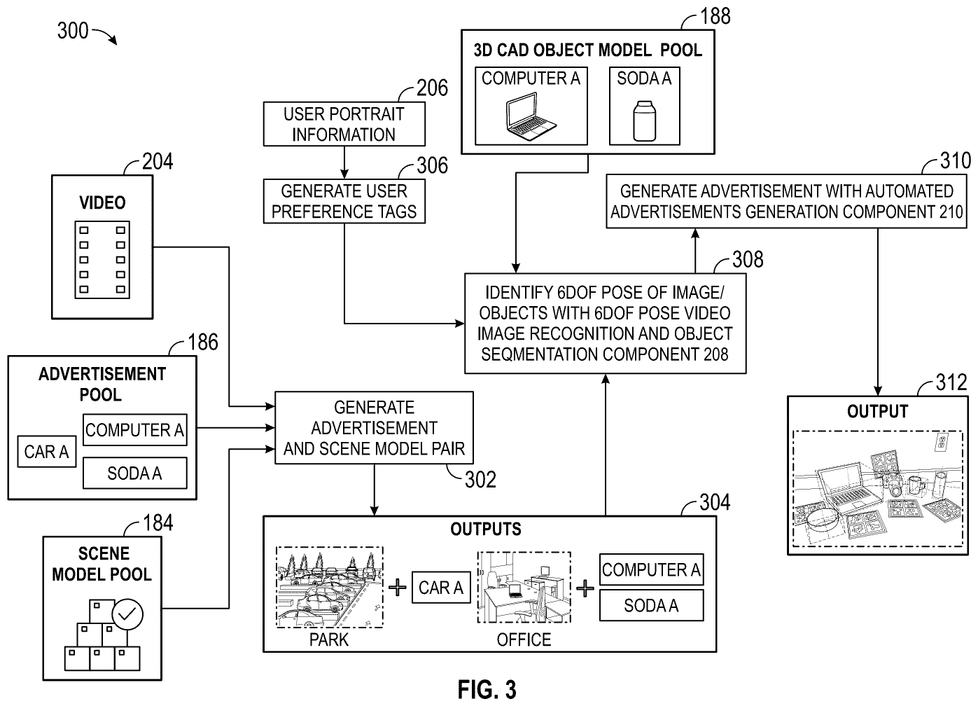

FIG. 3 schematically illustrates example operations 300 of the Video advertisement system 200 for generating precise and dynamic video placement advertisements with scene recognition and user portrait analysis of one or more disclosed embodiments. At block 302, Video advertisement system 200 receives inputs from a given video 206, the Advertisement Pool 186, and the Scene Model Pool 184 and generates an advertisement and scene model pair. That is, the Video advertisement system 200 selects one or more products, brands, advertising object candidates related to the recognized scene of the video that can be added to the video and used for generating the dynamic video placement advertisements. Video advertisement system 200 analyzes the video with respective scene models, to identify scenes of video, and according to the scenes, selects products and brands candidates for generating video advertisements. At block 304, illustrated example outputs of block 302 include a parking lot scene with a selected car brand, and an office scene with related office products, such as including an example computer, printer or various other products, to replace or add to the particular video scene. At block 306, Video advertisement system 200 receives collected user information 206 and generates user preference tags. At block 308, Video advertisement system 200 receives user preference tags, outputs 304 and selected identified 3D object inputs from 3D CAD Object Model Pool 188 to identify the 6DOF pose of the identified 3D objects with objects in the video image using the 6DOF Pose Video Image Recognition and Object Segmentation Component 208.

At block 310, Video advertisement system 200 the identified 6DOF pose for the selected 3D objects with objects in the video image and renders the video with customized advertisements based on the user preference tags, generated advertising video clips for selected commercial products, and the original video. For example, based on the user preference tags, a drink container in the video image can be replaced with one or more different selected 3D objects of a different drink brand or manufacturer for the dynamically video placement advertisements. At block 310, Video advertisement system 200 provides the same 6DOF pose to place each replacement or added advertisement product from the 3D CAD Object Model Pool 188 in the video. At block 312, an example output with the customized advertisement includes a replacement computer video image (such as of a Laptop Company A computer) with the same identified 6DOF pose of the original computer and optionally various other replacement and added advertising 3D objects, selected for a specific user or user group with identified similar preferences.

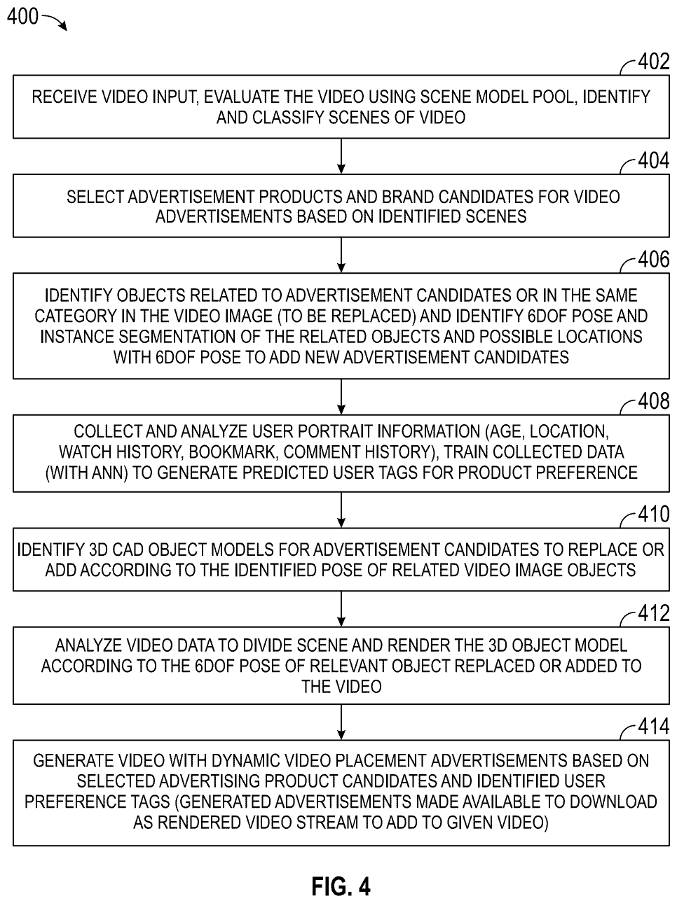

Referring to FIG. 4, an example method 400 may be implemented with computer 101 for example; with operations of method 400 controlled by the Advertisement Generation Control Component 182 together with the Scene Model Pool 184, Advertisement Pool 186, and 3D CAD Object Model Pool 188 for generating enhanced dynamic video placement advertisements with scene recognition and user portrait analysis.

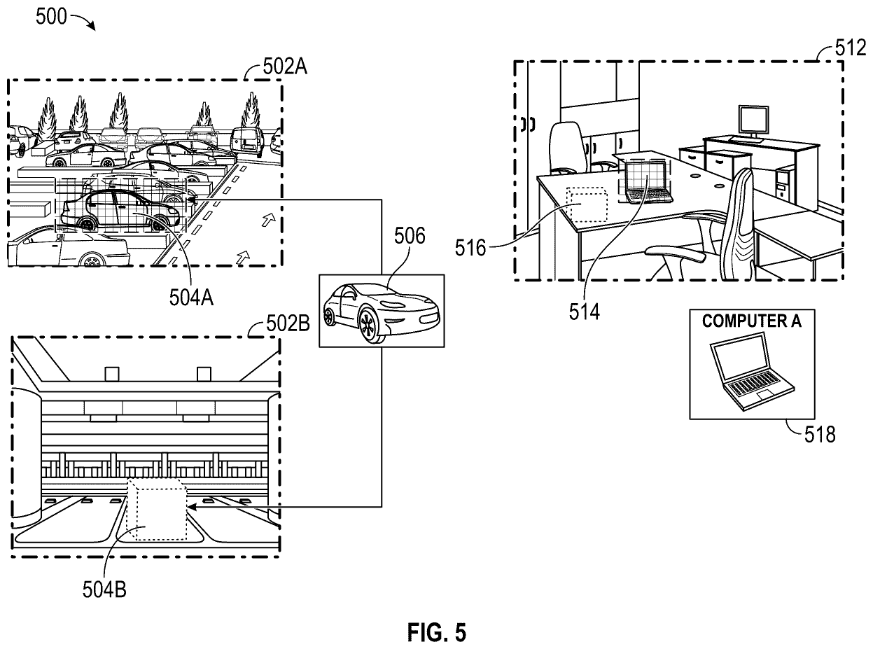

At block 402, Video advertisement system 200 receives a given video 204 and evaluates the video with scene models to identify and classify scenes in the video. At block 404, Video advertisement system 200 identifies related products and brands candidates based on the recognized scenes of the video, such as shown in the example illustrations of FIG. 5.

Referring to FIG. 5 schematically illustrated example operations 500 for scene classification and advertisement selection of Video advertisement system 200 show a pair of recognized video scenes 502A, 502B. Video scene 502A and 502B identify parking lots or parking areas in a given video 204. Video advertisement system 200 identifies respective locations 504A and 504B in the corresponding video scenes 502A, 502B to add selected advertising products and brand candidates in the identified locations. For example, one or more selected advertising products candidates can be selected from the Advertisement Pool 186 and 3D CAD Object Model Pool 188 to be added at locations 504A and 504B in the video scenes. For example, Video advertisement system 200 adds an illustrated advertising candidate 506 or other car parking lot-related advertisements, replacing cars in the image contents at location 504A and adding to the image contents of the open parking space at location 504B.

FIG. 5 schematically illustrates a recognized video scene 512 of an office scene and identifies one or more video locations 514, 516 in the office video scenes to add selected advertising product candidates in the identified locations. For example, one or more selected advertising products candidates related to the office video scene 512 can be selected from the Advertisement Pool 186 and 3D CAD Object Model Pool 188 to be added at the location 514 or 516. For example, Video advertisement system 200 adds an illustrated computer advertising candidate 518 or other office-related advertisements to the video location 514. Other office-related advertisements 518 optionally includes various commercial products, or 3D CAD Object Models related to an office video scene 512, such as other office equipment, food or drink products and the like.

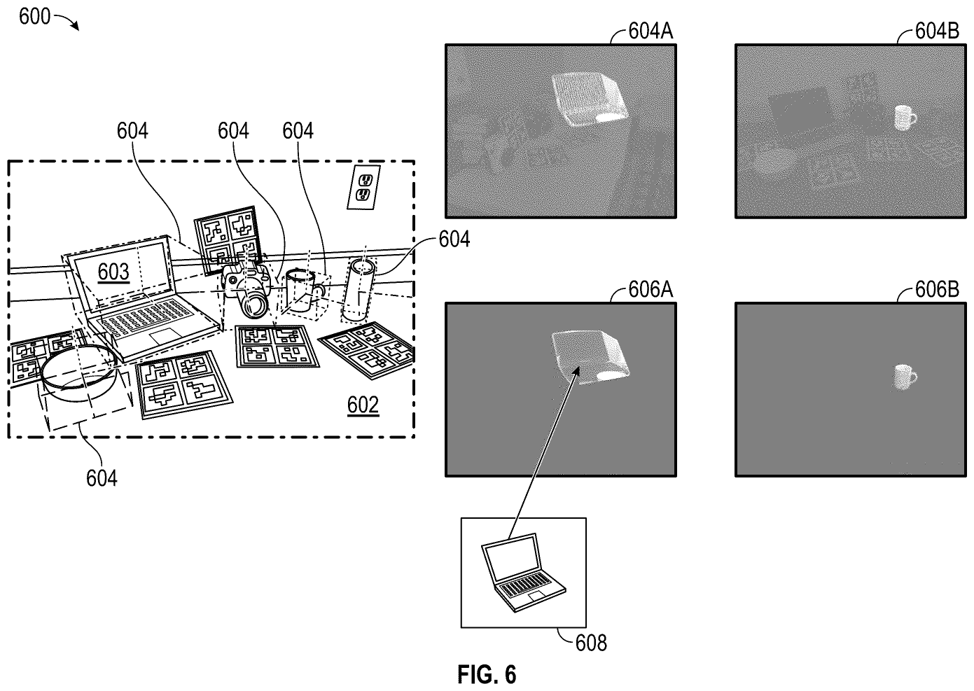

At block 406, Video advertisement system 200 identifies 3D objects related to the selected products and brands candidates and recognizes the 6DOF pose and instance segmentation of the objects in the video image, such as using a pose Convolutional Neural Network (CNN) method. For example, in one disclosed embodiment, the semantic segmentation branch adopts the common fully convolutional neural network CNN method. The prediction of translation matrix of the objects in the image is not directly output with the coordinates of the center point in the form of regression, because this method is insufficient or can fail when the center point is occluded. In one embodiment, the forecast center of each point on the object and the direction of connections between is used to predict the depth of each of the point values, each object is obtained by way of voting coordinates of the center of the point. Utilizing the semantic object segmentation results calculated with the depth of each point on the average value as the depth of the center point, the object segmentation can be calculated by inverse perspective transformation center space coordinates. The rotation transformation or rotation matrix is based on the Region of Interest (ROI) formed by the outer rectangular box of the object, and the quaternion is predicted by the way of regression. Unit or rotation quaternion provide a convenient mathematical notation for representing spatial orientations and rotations of elements in three-dimensional space. For example, blocks 604A. 604B, 606A, and 606B of FIG. 6 illustrate 6DOF pose and instance segmentation processing results for example advertising objects to add the video image.

Referring to FIG. 6, example operations 600 are schematically illustrated for object identification and 6DOF pose recognition of Video advertisement system 200 of disclosed embodiments. At block 602 in an illustrated recognized scene, Video advertisement system 200 can identify multiple video image objects related to the recognized scene and select such related video objects from the Advertisement Pool 186 (i.e., objects of the same category or related objects). Video advertisement system 200 optionally identifies an illustrated computer 603 to be replaced in the video content by one or more selected advertising objects from the Advertisement Pool 186, and 3D CAD Object Model Pool 188. As shown, Video advertisement system 200 identifies multiple (five) locations 604 where selected advertising objects can be added in the illustrated recognized scene 602. Blocks 604A and 604B illustrate respective 6DOF pose of video image objects or image area to be replaced by selected advertising objects comprising a computer and a cup provided by Video advertisement system 200. At blocks 606A and 606B, Video advertisement system 200 segments the video image objects or image area from the video image and replaces image objects by the selected advertising objects or adds selected advertising objects to the related area of the video image. For example, Video advertisement system 200 replaces the computer image object 606A by an illustrated selected advertising computer object 608.

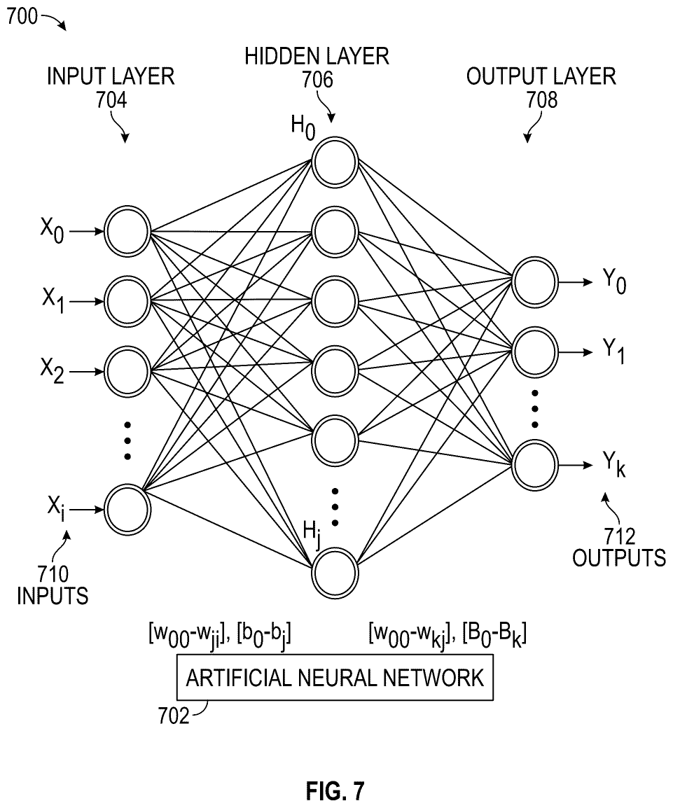

At block 408, Video advertisement system 200 receives collected user information 206 to generate predicted user preference tags to provide product preference for users. For example, generating user tags or predicting user preference tags of disclosed embodiments can comprise training of collected user information 206 with an Artificial or Neural Network (ANN) 702, as shown in FIG. 7. Processing available user information, including for example video viewing information and video browsing information and other demographic data for users can provide user preference tags in a form suitable for use by Video advertisement system 200. Video advertisement system 200 can select dynamic video placement advertisements likely to be of interest to a specific user or a cluster of users predicted to have similar preferences and interests. User preference tags enable the Video advertisement system 200 to accurately select advertising objects from the Advertisement Pool 186, and 3D CAD Object Model Pool 188 predicted to be of interest to the specific user or cluster of users.

FIG. 7 schematically illustrates example operations 700 of predicting user tags of Video advertisement system of FIG. 2 of disclosed embodiments. In FIG. 7, an example Artificial Neural Network (ANN) 702 includes an input layer 704, a hidden layer 706 and an output layer 708. Inputs 710 X0, X1, X2 . . . Xj applied to ANN 702 include collected user information 206, such as a public dataset of user age, video viewing and video browsing information. Outputs 712 Y0, Y1, . . . Yk of ANN 702 can provide effective user preference tags for selecting advertising objects of interest to a given user or users.

At block 410, Video advertisement system 200 identifies 3D CAD object models for advertisement candidates to replace or add to the video advertisement according to the identified pose of the related video image objects, such as identified at block 406. At block 412, Video advertisement system 200 analyzes video data to divide scene and render the 3D CAD object model or models according to the 6DOF pose of relevant object replaced (or for the object being added) to the one or more video advertisements. At block 414, Video advertisement system 200 generates the video with dynamic video placement advertisements based on selected advertising product candidates from the Advertisement Pool 186, and 3D CAD Object Model Pool 188 and the identified user preference tags. Video advertisement system 200 can generate the video with dynamic video placement advertisements based at least in part on the identified user preference tags, enables selecting only advertising products advertisements that are likely to be of interest to the specific user or cluster of users. Video advertisement system 200 can make the generated dynamic video placement advertisements available for download as a rendered video stream to be added to a given video.

While the foregoing is directed to embodiments of the present invention, other and further embodiments of the invention may be devised without departing from the basic scope thereof, and the scope thereof is determined by the claims that follow.

What is claimed is:

1. A method comprising:
evaluating a video to identify a scene model based on scene recognition in the video;
identifying an advertisement object to place in the video based on the identified scene model;
selecting one or more 3D object models for the identified advertisement object;
analyzing the video to obtain video content based on the identified scene model to identify locations to place the selected 3D object models in the video;
analyzing user portrait information to identify user preference tags; and
generating customized advertising content in the video based on the selected 3D object models and the identified user preference tags.

2. The method of claim 1, further comprising:
analyzing the video data to identify a 6DOF (Six degrees of freedom) pose of the selected 3D object model in the video according to the scene information, and
rendering the selected 3D model in the video based on the identified 6DOF pose.

3. The method of claim 1, further comprising:
collecting user portrait information for a user comprising one or more data types of video viewing information, video browsing information, and predefined demographic data for a user.

4. The method of claim 1, wherein analyzing user portrait information to identify user preference tags comprises collecting updated user portrait information for a user, and analyzing the updated user portrait information for dynamically identifying the user preference tags for generating customized advertising content in the video.

5. The method of claim 1, wherein evaluating the video to identify the scene model based on scene recognition in the video comprises accessing a scene model pool to identify multiple scene models and comparing the multiple scene models with video data content of the video to identify one or more scene models.

6. The method of claim 1, wherein identifying the advertisement object to place in the video based on the identified scene model comprises accessing an advertisement pool to identify multiple advertisements and compare the multiple scene models with video data content to identify one or more advertisement objects to place in the video.

7. The method of claim 1, wherein selecting one or more 3D object models for the identified an advertisement object comprises accessing a 3D object model pool for selecting a 3D object model based on multiple stored 3D object models.

8. The method of claim 1, wherein analyzing user portrait information to identify user preference tags comprises accessing a public information dataset and collecting available user preference information for a user from the public information dataset.

9. The method of claim 1, wherein generating customized advertising content in the video based on the selected 3D object models and identified user preference tags comprises generating the video with selected 3D object models to replace selected objects in video content in the video.

10. The method of claim 1, wherein generating customized advertising content in the video based on the selected 3D object models and identified user preference tags comprises generating the video with the selected 3D object models added to video content in the video.

11. A system, comprising:
a processor; and
a memory, wherein the memory includes a computer program product configured to perform operations for generating dynamic video placement advertisements, the operations comprising:
evaluating a video to identify a scene model based on scene recognition in the video;
identifying an advertisement object to place in the video based on the identified scene model;
selecting one or more 3D object models for the identified advertisement object;
analyzing the video to obtain video content based on the identified scene model to identify locations to place the selected 3D object models in the video;
analyzing user portrait information to identify user preference tags; and
generating customized advertising content in the video based on the selected 3D object models and the identified user preference tags.

12. The system of claim 11, further comprising:
analyzing the video data to identify the 6DOF (Six degrees of freedom) pose of the selected 3D object model in the video according to the scene information, and
rendering selected 3D models in the video based on the identified 6DOF pose.

13. The system of claim 11, further comprising:
collecting user portrait information for a user comprising one or more data types of video viewing information, video browsing information, and predefined demographic data for a user.

14. The system of claim 11, wherein analyzing user portrait information to identify user preference tags comprises collecting updated user portrait information for a user, and analyzing the updated user portrait information for dynamically identifying the user preference tags for generating customized advertising content in the video.

15. The system of claim 11, wherein identifying the advertisement object to place in the video based on the identified scene model comprises accessing an advertisement pool to identify multiple advertisements and comparing the multiple scene models with video data content to identify one or more advertisement objects to place in the video.

16. A computer program product for generating dynamic video placement advertisements, the computer program product comprising:
a computer-readable storage medium having computer-readable program code embodied therewith, the computer-readable program code executable by one or more computer processors to perform an operation comprising:
evaluating a video to identify a scene model based on scene recognition in the video;
identifying an advertisement object to place in the video based on the identified scene model;
selecting one or more 3D object models for the identified advertisement object;
analyzing the video to obtain video content based on the identified scene model to identify locations to place the selected 3D object models in the video;
analyzing user portrait information to identify user preference tags; and
generating customized advertising content in the video based on the selected 3D object models and the identified user preference tags.

17. The computer program product of claim 16 further comprising:
analyzing the video data to identify the 6DOF pose of the selected 3D object model in the video according to the scene information, and
rendering the selected 3D model in the video based on the identified 6DOF pose.

18. The computer program product of claim 16, wherein analyzing user portrait information to identify user preference tags comprises collecting updated user portrait information for a user, and analyzing the updated user portrait information for dynamically identifying the user preference tags for generating customized advertising content in the video.

19. The computer program product of claim 16, wherein identifying the advertisement object to place in the video based on the identified scene model comprises accessing an advertisement pool to identify multiple advertisements and comparing the multiple scene models with video data content to identify one or more advertisement objects to place in the video.

20. The computer program product of claim 16, wherein generating customized advertising content in the video based on the selected 3D object models and identified user preference tags comprises generating the video with selected 3D object models to replace selected objects in video content in the video.
